(19) United States
(12) Patent Application Publication
(10) Pub. No.: US 2008/0136784 A1
(43) Pub. Date: Jun. 12, 2008

(54) METHOD AND DEVICE FOR SELECTIVELY ACTIVATING A FUNCTION THEREOF

(75) Inventors: KIM KOON NEOH, PENANG (MY); TEE HOH QUAH, TAIPING (MY)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/567,584

(22) Filed: Dec. 6, 2006

(51) Int. Cl. G06F 3/041

(52) U.S. Cl. 345/173

(57) ABSTRACT

A method of activating a user function in an electronic device, the method comprising displaying an icon of the user function on a display of the device in response to detecting manual contact at a user's finger contact surface area at a corresponding tablet region of a touch sensitive tablet. Next there is performed activating the user function in response to actuation of a user input key of the device which corresponds with user's finger contact surface area on the touch sensitive tablet.

### FIELD OF THE INVENTION

The present invention relates generally to the field of user interfaces and user control of an electronic device. The invention is particularly useful for, but not necessarily limited to, user selection input on keypads or devices without touch sensitive screens.

### BACKGROUND OF THE INVENTION

Portable handheld electronic devices, such as handheld wireless communications devices (e.g., cellular telephones), that are easy to transport are becoming commonplace. Such handheld electronic devices come in a variety of different form factors and support many features and functions.

Cellular telephones, personal digital assistants (PDAs), tablet computers and other similar portable electronic devices, and electronic devices in general, sometimes have an input tablet that is typically a touch screen providing a two-way user interface for data entry, invoking applications and menu traversing. In an alternative approach, these electronic devices may offer a keypad including a small number of software defined keys (SDKs) adjacent a non-touch sensitive screen. Depending on the input mode of the electronic device, the SDKs allow a limited number of input options, such as selecting a user application to activate (e.g., activating or ending a call to a displayed contact, or confirming or cancelling a selection choice by actuating a “yes” or “no” SDK). Typically, a small screen icon or other display indication is provided on the screen next to each SDK. For example, one of the keys may have a box with “Call” or “Yes” displayed next to the key depending on the current mode of the device, in order to indicate to the user the current function of that key.

The use of SDKs, however, is currently very limited due to the limited space available on the screen adjacent the SDKs, which in turn limits the number of functions that may be allocated to these keys. Instead, such functions are typically implemented in multi-layer menu systems which are time-consuming and inconvenient for the user to use.

### BRIEF DESCRIPTION OF THE DRAWINGS

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic block diagram illustrating circuitry of an electronic device in accordance with the invention;

FIG. 2 illustrates a detailed arrangement of a keypad comprising a touch sensitive tablet, of the electronic device of FIG. 1, integrated with input keys;

FIG. 3 illustrates a physical embodiment of the electronic device of FIG. 1, comprising SDKs;

FIG. 4 illustrates operation of a screen, touch sensitive tablet and input keys of the electronic device of FIG. 1;

FIG. 5 illustrates a method of activating a user function of the electronic device of FIG. 1; and

FIG. 6 illustrates operation of a screen, touch sensitive tablet and input keys, of the electronic device of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

In general terms, there is provided a method of activating a user function, such as an email application or a user input selection, in an electronic device. The method comprises displaying an indication, such as an icon, of the user function on a display of the device in response to detecting manual contact at a corresponding region of a touch sensitive tablet of the device. The manual contact may be a finger or stylus touch detectable by a capacitive sensor for example. The user function is then activated in response to actuation of a user input key of the device which corresponds with the manually contacted region of the touch sensitive tablet.

In one embodiment, for example, a user may touch a user input key which causes the display of an icon indicating an associated user function, such as launching an email application. Further pressure on the user input key causes actuation of the user input key which causes the user function to activate. The use of a large number of user input keys to provide a selection of software defined functions increases the versatility of the electronic device, and the use of icons associated with the keys which are displayed or highlighted when the key is touched but not yet actuated allows easier user navigation of these available user functions.

Before describing in detail embodiments that are in accordance with the present invention, it should be observed that the embodiments reside primarily in combinations of method steps and device components related to user function activation on an electronic device. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the method, or device that comprises the element. Also, throughout this specification, the term “key” has the broad meaning of any key, button or actuator having a dedicated, variable or programmable function that is actuatable by a user.

It will be appreciated that embodiments of the invention described herein may be comprised of one or more conventional processors and unique stored program instructions that control the one or more processors to implement, in conjunction with certain non-processor circuits, some, most, or all of the functions of user function activation in an electronic device described herein. The non-processor circuits may include, but are not limited to, a radio receiver, a radio transmitter, signal drivers, clock circuits, power source circuits, and user input devices. As such, these functions may be interpreted as steps of a method to perform user function activation on an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

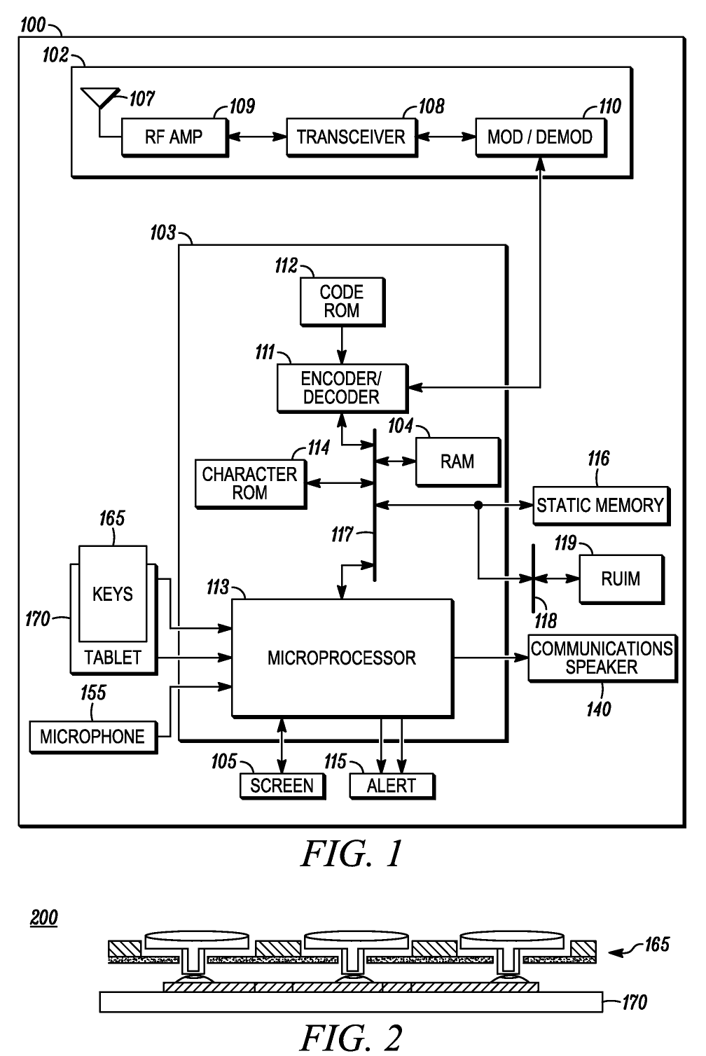

Referring to FIG. 1, there is a schematic diagram illustrating an electronic device 100, typically a wireless communications device, in the form of a mobile station or mobile telephone comprising a radio frequency communications unit 102 coupled to be in communication with a processor 103. The electronic device 100 also has a display screen 105 and input keys 165. There is also an alert module 115 that typically contains an alert speaker, vibrator motor and associated drivers. The display screen 105, input keys 165 and alert module 115 are coupled to be in communication with the processor 103. The electronic device 100 also comprises a touch sensitive tablet 170 coupled to the processor 103, the touch sensitive tablet 170 being adjacent to and in an overlapping relationship with the input keys 165.

The processor 103 includes an encoder/decoder 111 with an associated code read-only memory (ROM) 112 for storing data for encoding and decoding voice or other signals that may be transmitted or received by the electronic device 100. The processor 103 also includes a micro-processor 113 coupled, by a common data and address bus 117, to the encoder/decoder 111, a character ROM 114, radio communications unit 102, a random access memory (RAM) 104, static programmable memory 116 and a removable user identity module (RUIM) interface 118. The static programmable memory 116 and a RUIM card 119 (commonly referred to as a subscriber identity module (SIM) card) operatively coupled to the RUIM interface 118 each can store, amongst other things, preferred roaming lists (PRLs), subscriber authentication data, selected incoming text messages and a telephone number database (TND phonebook) comprising a number field for telephone numbers and a name field for identifiers associated with one of the numbers in the name field. The RUIM card 119 and the static programmable memory 116 may also store passwords for allowing accessibility to password-protected functions on the mobile telephone 100.

The micro-processor 113 has ports for coupling to the display screen 105, the keys and the alert module 115. Also, micro-processor 113 has ports for coupling to a microphone 135 and a communications speaker 140 that are integral with the device.

The character ROM 114 stores code for decoding or encoding text messages that may be received by the radio frequency communications unit 102. In this embodiment, the character ROM 114, the RUIM card 119, and the static programmable memory 116 may also store operating code (OC) for the micro-processor 113 and code for performing functions associated with the mobile telephone 100.

The radio frequency communications unit 102 is a combined receiver and transmitter having a common antenna 107. The radio frequency communications unit 102 has a transceiver 108 coupled to the common antenna 107 via a radio frequency amplifier 109. The transceiver 108 is also coupled to a combined modulator/demodulator 110 that couples the radio frequency communications unit 102 to the processor 103.

The touch sensitive tablet 170 detects manual contact from a user's finger or stylus and although shown separately here for simplicity may be integrated with the input keys 165 or the display screen 105 of the device 100. The detected manual contacts are interpreted by the processor 103 as points or lines of contact or touch across an x-y coordinate system of the touch sensitive tablet 170. The interpretation of the detected manual contacts as points or lines of contact by the processor 103 will typically be implemented with the execution of program code as will be appreciated by those skilled in the art. In alternative embodiments, this function may be achieved using an ASIC or equivalent hardware.

FIG. 2 illustrates a detailed arrangement of a keypad 200 comprising the user the touch sensitive tablet 170 integrated in an assembly with input keys 165. The touch sensitive tablet 170 provides a touch sensitive user interface on the electronic device 100 which allows for receiving user contact or touch points or lines of contact with the touch sensitive tablet 170. Such tablets are typically implemented using an array of capacitive sensors which detect changes in capacitance corresponding to the presence of a finger or other object such as a stylus. Detection of a user interface or entry object such as a finger or stylus therefore does not require pressure against the sensor array or tablet, but typically just a light touch or contact against the surface of the tablet; or even just close proximity. Thus, it is possible to provide an integrated assembly of the input keys 165 and the touch sensitive tablet 170, as the input keys 165 require physical pressure for actuation whereas the capacitive sensors do not. Therefore, it is possible to activate the touch sensitive tablet 170 in order to detect a manual contact without actuating the input keys 165. An example of a touch sensitive tablet 170 is the finger writing recognition tablet on the A668 mobile phone available from Motorola Incorporated.

Whilst capacitive sensors are typically used, other sensor arrays may alternatively be used such as ultrasound sensors to detect the user input object's position. Similarly the “activation” of a sensor may be configured to correspond to contact between a user input object, such as a finger, and the surface of the tablet, or even close proximity of the distal end of a user input object with the sensor such that actual physical contact with the tablet surface may not be required.

The changes in capacitance detected at the sensors are translated into a contact location by the processor 103. Alternatively, the points or strokes of contact may be captured by an ink trajectory processor as ink trajectories with respect to the coordinate system of the touch sensitive tablet 170. These inks of manual contact locations are then forwarded to the microprocessor 113 and interpreted as manual contact locations for further processing as described in more detail below. A suitable ink trajectory processor may be that used in the Motorola™ A688 mobile phone.

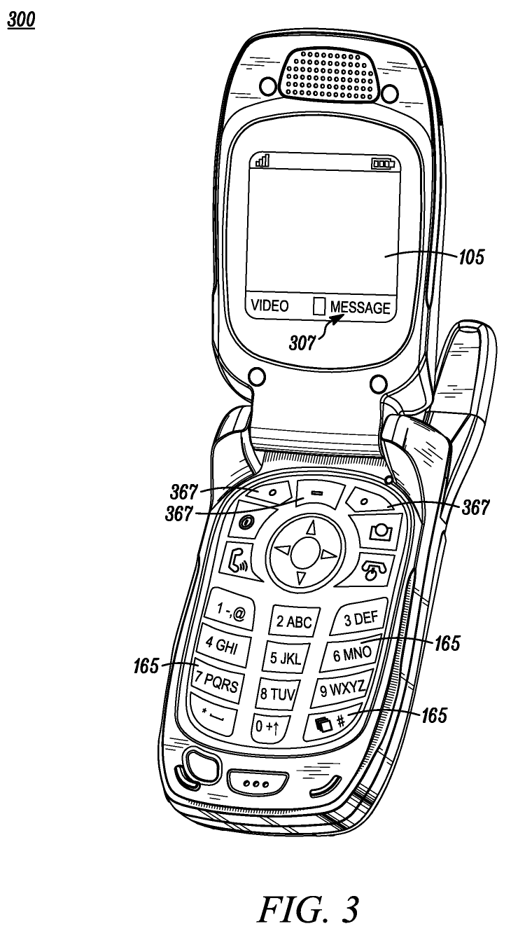

FIG. 3 illustrates a physical embodiment of the electronic device 100 comprising SDKs 367. The SDKs 367 are a typically a subset of the input keys 165 and these SDKs 367 are usually adjacent the display screen 105. The functions of the SDKs 367 can be changed according to the user application or mode displayed on the display screen 105. For example, in a “phone” mode, one of the SDKs 367 may be configured to activate a contacts application when actuated by a user in order to select a contact for calling. In an email mode or application, the same key may be configured to select an email from a list for more detailed contents display. In yet another mode, the SDKs 367 may be used to allow a user to confirm (“YES”) a previous user selection, for example, deleting a voice mail. The display screen 105 includes function display region 307 located adjacent the SDK's 367 in order to indicate to the user the current function of each of the SDKs. Thus, in the above described examples, the function display region 307 may typically display icons of word tags that can be 10 selected by an appropriate one of the SDKs 367, such functions or user applications (including input and control commands) may be “Address Book”, “Select”, and “Yes” functions. Typically, however, such mobile phones have only two or three SDK's 367, which limit the effectiveness of using SDK's.

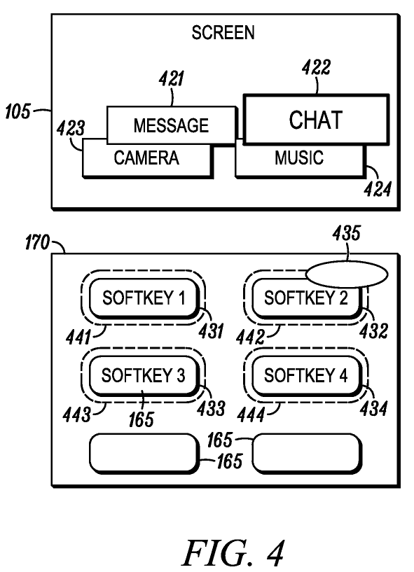

FIG. 4 illustrates operation of the display screen 105, touch sensitive tablet 170 and an array of some of the input keys 165. Such an arrangement of the array of some of the input keys 165 and touch sensitive tablet 170 is available in, for example, the Motorola™ A668 mobile phone, although alternative sources and arrangements could be used. All or a subset of the user actuable keys 465 may be configured as the SDKS; and four SDK's 431, 432, 433, and 434 are illustrated in the example of FIG. 4. Each of the SDK's 431-434 may be defined to correspond to a number of different user functions depending on the mode of the device 400. In the example shown, each of the SDKs corresponds to one of the following user applications: message (431); camera (433); chat (432); music (434). These user function options can, but are not necessarily, displayed in the function display region 307, and are represented as user function icons 421-424 respectively on the display screen 105 of the device 100. In this embodiment, each user function icon 421-424 corresponds to a single SDK 431-434. For example, the “Softkey2” SDK 432 corresponds to the “Chat” icon 422 which launches a Chat or Instant Messaging user application.

Each SDK 431-434 also corresponds with a location or tablet region 441-444 on the touch sensitive tablet 170. In this example implementation, each tablet region 441, 442, 443, and 444 corresponds with the location of an SDK 431, 432, 433, and 434 respectively; for example being largely co-located as shown in dashed outline. Touching or manually contacting one of these tablet regions 441-444 is detected by the touch sensitive tablet 170 and processor 103 of the device 100, and causes an indication of the user function associated with the SDK 431-434 adjacent to or co-located with the corresponding SDK. For example, the “Chat” user function of FIG. 4 is indicated by enlarging the corresponding “Chat” icon 422 on the display when a user's finger contact surface area 435 touches the touch sensitive tablet 170 in the corresponding tablet region 442 surrounding the second SDK 432 (Softkey2). Similarly, if the user's finger contact surface area 435 were to manually contact the tablet region 443 corresponding to the third SDK (Softkey3) 433, then the “Camera” icon 423 is indicated by displaying an enlargement of this icon 423.

Alternative mechanisms for indicating on the display 405 the user function associated with a SDK 431-434 may be used, for example, the corresponding screen icon 421-424 may be made to flash, change colour, or overwrite all other SDK related icons. In a further alternative, the icons corresponding to the various SDKs may only be displayed when the respective SDK 431-434 or surrounding tablet region 441-444 is manually contacted; otherwise, these icons are hidden. Further indications of user functions currently assigned to each SDK may be envisioned by the skilled person, including replacing icons with other display features, such as text or menus. Thus, from the above, it will be apparent that the input keys 165 are integrated with the touch sensitive tablet 170 such that each tablet region 441-444 of the touch sensitive tablet 170 corresponds to one of a number of user functions and the corresponding input keys 165 are substantially co-located with a respective tablet region 441-444.

Once a user function indication (e.g., Chat 422) has been displayed in response to manual contact of the corresponding tablet region (442) of the tablet 470, and/or the corresponding SDK (432), further manual pressure on the SDK (432) by a user's finger on the user's finger contact surface area 435 causes the electronic device 400 to activate or invoke the corresponding user function (e.g., Chat application).

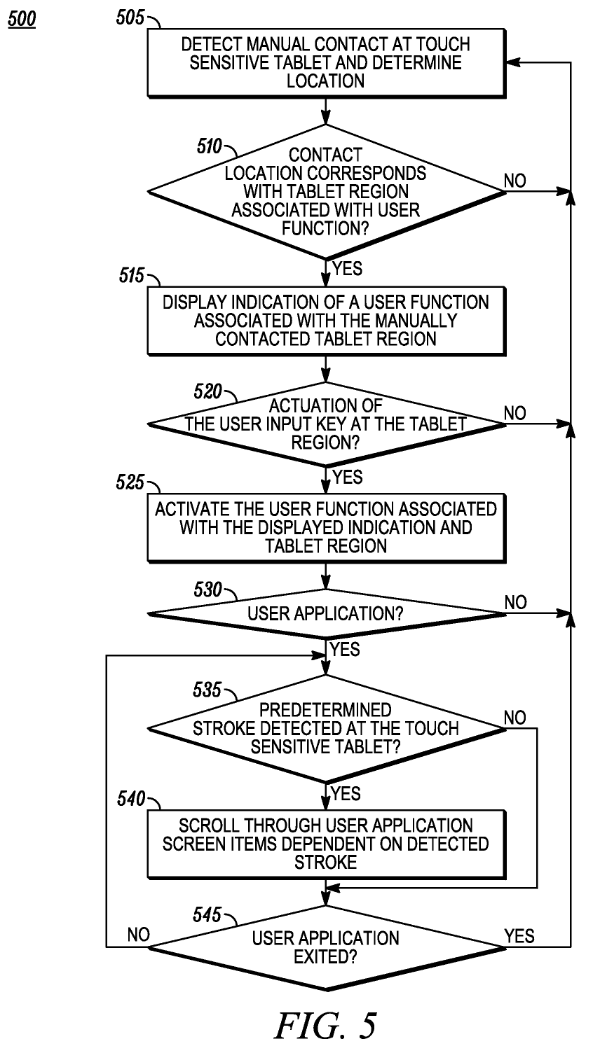

FIG. 5 illustrates in more detail a method of operating the electronic device 100 in order to provide the above functionality. This functionality is typically implemented by executing a software program from the static programmable memory 116 on the microprocessor 113 which receives inputs from the touch sensitive tablet 170 and input keys 165. The method (500) detects manual contact or user touch or proximity at the touch sensitive tablet 170. This is detected by the capacitive or other sensors embedded in the tablet. The location of the manual contact is determined by the processor 103 or equivalent function. The method determines whether the contact location detected corresponds with one of the tablet regions 441-444 allocated to one of a number of user functions (510). The allocation of tablet regions (and therefore input keys specifically the SDKs) to identify and select respective user functions may be configurable by the user or solely dependent on the current mode or application displayed by the device 100. Each tablet region 441-444 corresponding to a user function is associated with one of the SDKs 432-434. Typically, this association is co-location of the SDK and one of the tablet regions 441-444, although alternative associations are contemplated, for example, close proximity as opposed to co-location or overlapping location. If the detected contact location does not correspond with a tablet region 441-444 associated with a user function (510N), then the method returns to detect further manual contacts (505). If, however, the user's finger contact surface area 435 corresponds with a tablet region (e.g., 442) associated with a user function (510Y), for example a “Chat” application or a “Yes” selection, the method displays an indication (e.g., 422) of the associated user function (515) that is associated with the manually contacted tablet region (user's finger contact surface area 435). Thus, the user function, displayed on the display screen 105 of the device 100, is displayed in response to detecting manual contact at a corresponding region of a touch sensitive tablet of the device 100. The indication may be the enlargement or other highlighting of an existing on-screen icon, or the presentation of a previously hidden icon or changing a corresponding icon on the display screen 105 or any other display feature.

The method (500) then determines whether the user has actuated the SDK (e.g., 432) associated with the manually contacted tablet region (e.g., 442) and indicated user function (e.g., Chat) (520). If a user selection has not been made (520N), the method returns to detect further manual contact (505). Determination of no user selection (520N) may be implemented in response to exceeding a predetermined duration without user actuation of the SDK 432 or by detecting that there is no longer any manual contact at the corresponding tablet region 442. If the user has selected the indicated user function by actuating the corresponding SDK (520Y), for example within a predetermined time, then the method activates the user function (525) in response to actuation of the user input key of the device which corresponds with the manually contacted region (user's finger contact surface area 435) of the touch sensitive tablet 170. For example, in the present mode, the “Chat” application may be launched by the device 100, 400. Alternatively, a previously selected function, such as “delete contact”, may be activated by the user confirming this previous selection with a “Yes” selection using the present embodiment.

In this embodiment, the method (500) determines whether the user function selected by the user (i.e., a user defined application) is one of a number of predetermined user applications such as an email client (530). If not (530N), for example the user function selection was merely “Yes” or “No” in a user confirmation mode, then the method returns to detect further manual contact at the tablet (505). If, however, the user function is one of a number of predetermined user applications, such as an email client (530Y), then the method monitors for strokes entered at the touch sensitive tablet 170 (535)

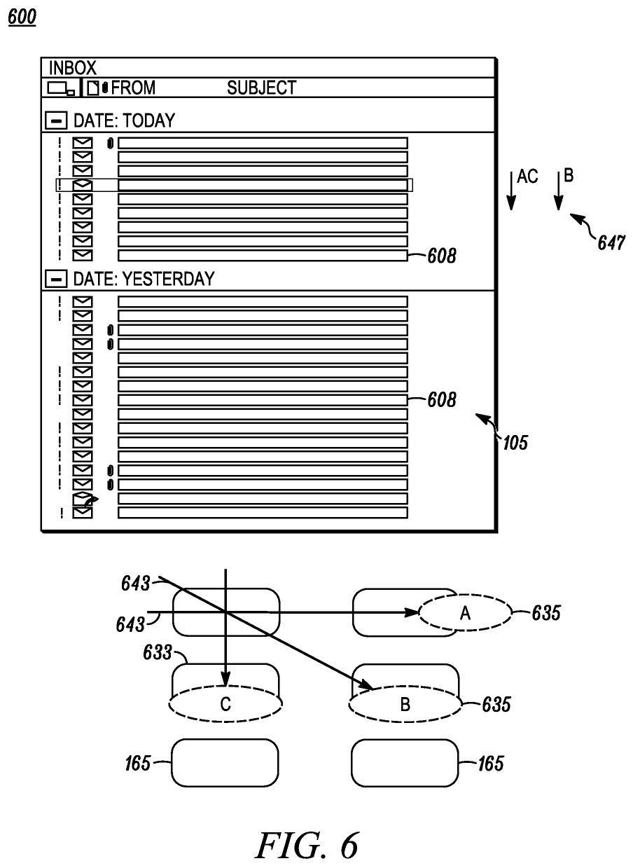

If one of a number of predetermined strokes are detected (535Y), for example, a movement of manual contact across the tablet from a first SDK 431 to a second SDK 432, the method scrolls though a list of items from within the user application in a predetermined manner (540). For example, a cursor in an email client may be made to scroll through a list of emails, one email for each stroke between these two SDK's. With a different stroke, for example, from a first SDK 431 to a third SDK 433 requiring a diagonal stroke across the keypad, the cursor may scroll two emails for each such stroke. This example is described in more detail with respect to FIG. 6. The method (500) then determines whether the current application has been exited (545). Similarly, if no predetermined stroke was detected (535), for example, after a predetermined time, then the method determines whether the current application has been exited (545). If the application has not yet been exited (545N), then the method returns to determine whether further predetermined strokes have been received (535). If the application has been exited (545Y), then the method returns to detect manual contact for the purpose of indicating further user functions as described previously (505).

FIG. 6 illustrates operation of the display screen 105, touch sensitive tablet 170 and input keys 165, of the electronic device 100. The display screen 105 is displaying an email client inbox having a number of emails items 608, each represented by a single line entry in a list of such items. Following indication and activation of the email client according to the method of FIG. 5 (steps 505-525), predetermined strokes or trajectories of manual contact are received at the touch sensitive tablet 170. Three such strokes are illustrated by lines 643 across some of the input keys 165 of the device 100. The lines 643 indicate the trajectory of a finger or stylus across the tablet and keys. The first stroke (labelled A) runs horizontally across two SDK's (431 and 432) and/or their corresponding tablet regions (441 and 442). This results in the cursor on the displayed emails list moving down one email item 608 for each such stroke. This is indicated by the AC line referenced 647. The second stroke (labelled B) runs diagonally across two SDK's (431 and 434) and/or their corresponding regions (441 and 444) and results in the cursor on the displayed emails list moving down two email items 608 for each such stroke. This is indicated by the B line referenced 647. The third stroke (labelled C) runs vertically across two SDK's (431 and 433) and/or their corresponding tablet regions (441 and 443) and results in the cursor on the displayed emails list moving down one email item 608 for each such stroke. This is indicated by the AC line referenced 647.

Alternative cursor movement to tablet stroke mappings could be implemented as would be understood by those skilled in the art. Thus, the present invention provides for scrolling, or searching, through a list of items one at a time within a selected user defined application in response to horizontal or vertical movement between two of the input keys 165. Also, scrolling through a list of items two at a time within the selected user defined application in response to diagonal movement between two user input keys can also be achieved by the present invention. Those skilled in the art would understand how to implement this scrolling behaviour in response to tablet received strokes using suitable email client and other user application programmer interfaces (APIs), and therefore in depth low level detail of scrolling techniques is not described.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. A method of activating a user function in an electronic device, the method comprising:
displaying an indication of the user function on a display of the device in response to detecting manual contact at a corresponding region of a touch sensitive tablet of the device;
activating the user function in response to actuation of an input key of the device which corresponds with the manually contacted region of the touch sensitive tablet.

2. The method of activating the user function in the electronic device as claimed in claim 1 wherein the indication of the user function comprises changing a corresponding icon on the display.

3. The method of activating the user function in the electronic device as claimed in claim 1 wherein the indication of the user application comprises displaying a previously hidden icon on the display.

4. The method of activating the user function in the electronic device as claimed in claim 1 wherein a number of input keys are integrated with the touch sensitive tablet such that each region of the touch sensitive tablet corresponding to one of a number of user functions and the corresponding input keys are substantially co-located with a respective region.

5. The method of activating the user function in the electronic device as claimed in claim 4 wherein the allocation of the input keys to identify and select respective user functions is configurable by the user.

6. The method of activating the user function in the electronic device as claimed in claim 5 wherein the user function is a user defined application.

7. The method of activating the user function in the electronic device as claimed in claim 6 further comprising navigating through the selected user defined application in response to detecting movement of the manual contact from a region at the touch sensitive tablet corresponding to one input key to a region at the touch sensitive tablet corresponding to another user input key.

8. The method of activating the user function in the electronic device as claimed in claim 7, further comprising scrolling through a list of items one at a time within the selected user defined application in response to horizontal or vertical movement between two of the input keys.

9. The method of activating the user function in the electronic device as claimed in claim 7, further comprising scrolling through a list of items two at a time within the selected user defined application in response to diagonal movement between two user input keys.

10. An electronic device comprising a processor arranged to display an indication of a user function on a display of the device in response to detecting manual contact at a corresponding region of a touch sensitive tablet of the device, the processor further arranged to activate the user function in response to actuation of an input key of the device which corresponds with the manually contacted region of the touch sensitive tablet.

11. The electronic device as claimed in claim 10 wherein a number of user input keys are integrated with the touch sensitive tablet such that each region of the touch sensitive tablet corresponding to a number of user functions and the corresponding input keys are substantially co-located.

12. The electronic device as claimed in claim 11 wherein the activated user function is a user defined application and the processor is further arranged to navigate through the activated user defined application in response to detecting movement of the manual contact from a region at the touch sensitive tablet corresponding to one input key to a region at the touch sensitive tablet corresponding to another input key.
